(19) United States
(12) Patent Application Publication
(10) Pub. No.: US 2006/0242234 A1
(43) Pub. Date: Oct. 26, 2006

(54) Dynamic group formation for social interaction

(75) Inventors: Scott J. Counts, Seattle, WA (US); Shelly D. Farnham, Seattle, WA (US); Jordan LK Schwartz, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/111,017

(22) Filed: Apr. 21, 2005

(51) Int. Cl. G06F 15/16

(52) U.S. Cl. 709/204

(57) ABSTRACT

A system and method that facilitates dynamic group formation for social interaction and/or real-time sharing of content with the group is provided. A group formation system includes a user interface component that facilitates a user's entry of information and display of information regarding group formation. For example, the user interface component can be employed, for example, with a mobile communication device such as a mobile phone, personal digital assistant (PDA), a smart phone, a small, web based mobile or a wireless application protocol (WAP) client, and/or a regular web client. The system can further include a group formation component that forms a group based, at least in part, upon information received from a user via the interface component. The group configuration component can further store information regarding groups (e.g., a name/identifier, member(s), event(s) and/or shared context associated with the group) in a group information data store. For example, the group configuration component can form a group based, at least in part, upon information stored in the group information data store (implicit group formation). The group information data store can, optionally, provide archival access to communications and/or shared content (e.g., through a mobile communications device and/or a PC-based web browser).

### TECHNICAL FIELD

The subject invention relates generally to mobile communications, and, more particularly, to dynamic group formation for social interaction and/or real-time sharing of content with the formed group.

### BACKGROUND OF THE INVENTION

The last ten years have seen mobile phones revolutionize how people communicate, coordinate, and socialize. Mobile phones have become an integral part of the feeling of connectedness that friends and family share with one another, allowing them to keep in touch, regardless of location. While voice communication is highly natural and expressive, it also requires immediate attention, occasional privacy, quiet surroundings, and does not scale well for coordinating within medium/large groups of people.

Text messaging, also know as SMS (Short Message Service), is a lightweight text communication tool for mobile phones. As the name implies, messages are very short, limited to 160 characters for most encoding schemes. SMS allows one person with an SMS-enabled phone to send a text message to another person with an SMS-enabled phone. SMS-enabled phones are in widespread use in Europe and Japan and gaining acceptance in the United States.

Existing technologies do not support simple, flexible formation of groups of people for messaging, event coordination, and/or content sharing. In physical social lives, people continually come together in informal groups of different people to exchange photos, attend events, discuss topics, and so forth, yet no conventional technology supports this evolving, informal group dynamic.

### SUMMARY OF THE INVENTION

The following presents a simplified summary of the subject invention in order to provide a basic understanding of some aspects of the subject invention. This summary is not an extensive overview of the subject invention. It is not intended to identify key/critical elements of the subject invention or to delineate the scope of the subject invention. Its sole purpose is to present some concepts of the subject invention in a simplified form as a prelude to the more detailed description that is presented later.

The subject invention relates to a system and methodology that facilitate dynamic group formation for social interaction and/or real-time sharing of content with the group. In accordance with an aspect of the subject invention, a group formation system is provided. The system can facilitate creation of dynamic, shared group(s) which allow for real-time communication and/or media sharing with members of the group. The system can be employed, for example, with a mobile communication device such as a mobile phone, personal digital assistant (PDA) and/or smart phone.

The system can be employed to form groups that are persistent (e.g., family, friends) and/or event-specific (e.g., birthday party, potluck dinner etc.) Once a group is created with the system, users can send and/or receive text and/or photo messages to/from that group, thus allowing members of the group to coordinate and communicate in real-time.

The system can include a user interface component that facilitates a user's entry of information and display of information regarding group formation. For example, the user interface component can be employed, for example, with a mobile communication device such as a mobile phone, personal digital assistant (PDA), a smart phone, a small, web based mobile or a wireless application protocol (WAP) client, and/or a regular web client. In accordance with an aspect of the subject invention, a user can be provided with multiple interfaces via the user interface component to form a group of people.

The system can further include a group configuration component that forms a group based, at least in part, upon information received from a user via the interface component. The group configuration component can further store information regarding groups, for example, a name/identifier, member(s), event(s) and/or shared context associated with the group in a group information data store (e.g., database that maintains group, event, and person information). In one example, the group configuration component can form a group based, at least in part, upon information stored in the group information data store (implicit group formation). The group information data store can, optionally, provide archival access to communications and/or shared content (e.g., through a mobile communications device and/or a PC-based web browser).

As noted previously, the group configuration component can employ implicit group formation to assist a user in configuring a group. For example, by sending a message with a date attached to a group of people, an “event” for the specified date along with a group for the event can be created. In one example, if this message gets forwarded to someone not in the original group that person can become part of the group.

In another example, the group configuration component can use co-occurrence in previous groups to suggest groups based on affinity between people. For example, as a user is creating a new group, the group configuration component can suggest people likely to be included in the group based on a person and/or persons included initially (e.g., “seed person”). This can lead to “lightweight” group formation, that is, not requiring substantial user input. Another type of group is one with a common purpose, for example, a “Seattle camera phone photographers” group whose sole purpose was to share pictures with one another.

In yet another example, the group configuration component can employ general affinity to suggest people in a group. For example, people attending a trade show and stop at the same booths could be implicitly grouped (e.g., based on GPS and/or scanner tracking software to track what booths people visited).

Finally, the group configuration component can suggest a grouping of people based on physical proximity to one another. For example, physical proximity can be determined through a location service, such as GPS and/or telecommunication-provided location, or peer-to-peer. In the peer-to-peer cases, two people can form a group, for example, when their smart devices are in close proximity. A third person can join the group when his/her device is in close proximity to one of the first two. These groups can then be used for communication and sharing.

Once a group has been formed by the system, the group can be employed for communications, content sharing and/or event planning, for example, integrated with lightweight mobile technologies such as HTTP over cellular network, SMS and/or WAP.

To the accomplishment of the foregoing and related ends, certain illustrative aspects of the subject invention are described herein in connection with the following description and the annexed drawings. These aspects are indicative, however, of but a few of the various ways in which the principles of the subject invention may be employed and the subject invention is intended to include all such aspects and their equivalents. Other advantages and novel features of the subject invention may become apparent from the following detailed description of the subject invention when considered in conjunction with the drawings.

### BRIEF DESCRIPTION OF THE DRAWINGS

FIG. 1 is a block diagram of a group formation system in accordance with an aspect of the subject invention.

FIG. 2 is an exemplary user interface in accordance with an aspect of the subject invention.

FIG. 3 is an exemplary user interface in accordance with an aspect of the subject invention.

FIG. 4 is a block diagram of a group social interaction system in accordance with an aspect of the subject invention.

FIG. 5 is an exemplary user interface in accordance with an aspect of the subject invention.

FIG. 6 is an exemplary user interface in accordance with an aspect of the subject invention.

FIG. 7 is an exemplary user interface in accordance with an aspect of the subject invention.

FIG. 8 is an exemplary user interface in accordance with an aspect of the subject invention.

FIG. 9 is an exemplary user interface in accordance with an aspect of the subject invention.

FIG. 10 is an exemplary user interface in accordance with an aspect of the subject invention.

FIG. 11 is an exemplary user interface in accordance with an aspect of the subject invention.

FIG. 12 is an exemplary user interface in accordance with an aspect of the subject invention.

FIG. 13 is an exemplary user interface in accordance with an aspect of the subject invention.

FIG. 14 is an exemplary user interface in accordance with an aspect of the subject invention.

FIG. 15 is an exemplary user interface in accordance with an aspect of the subject invention.

FIG. 16 is an exemplary user interface in accordance with an aspect of the subject invention.

FIG. 17 is an exemplary user interface in accordance with an aspect of the subject invention.

FIG. 18 is an exemplary user interface in accordance with an aspect of the subject invention.

FIG. 19 is a flow chart of a method of forming a group in accordance with an aspect of the subject invention.

FIG. 20 illustrates an example operating environment in which the invention may function.

FIG. 21 illustrates an exemplary networking environment that can be employed in connection with the subject invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the subject invention.

The subject invention can incorporate various inference schemes and/or techniques in connection with formation of a group based, for example, upon context and/or previously formed group(s). As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The subject invention relates to a system and methodology that facilitate dynamic group formation for social interaction and/or real-time sharing of content with the group. For example, a particular group can be associated with a group of friends, colleagues, relatives, and the like.

In physical social lives, people continually come together in informal groups of different people to exchange photos, attend events, discuss topics, and so forth, yet conventional technology does not support this evolving, informal group dynamic. As noted previously, existing technologies do not support simple, flexible formation of groups of people for messaging, event coordination and/or content sharing. The system and method of the subject invention facilitate the dynamic creation/modification of groups as well as content sharing (e.g., real-time) between group members.

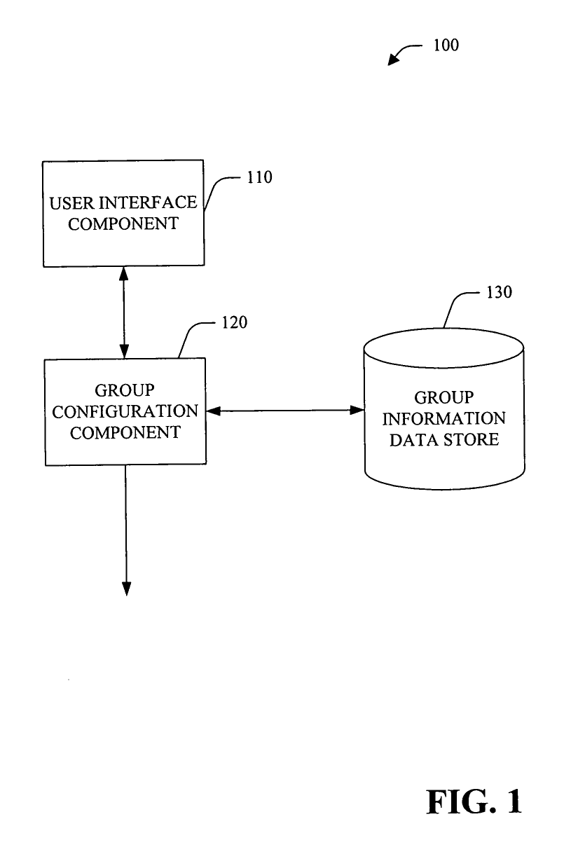

Referring to FIG. 1, a group formation system 100 in accordance with an aspect of the subject invention is illustrated. The system 100 can facilitate creation of dynamic, shared group(s) which allow for real-time communication and/or media sharing with members of the group. The system 100 can be used, for example, with a mobile communication device such as a mobile phone, personal digital assistant (PDA) and/or smart phone.

The system 100 can be employed to form groups that are persistent (e.g., family, friends) and/or event-specific (e.g., birthday party, potluck dinner etc.) Once a group is created with the system 100, users can send and/or receive text and/or photo messages to/from that group, thus allowing members of the group to coordinate and communicate in real-time.

For example, a user can decide to hold an impromptu event (e.g., a dinner party). With the system 100, the user can create a dynamic communication group of the user's friends with the user's mobile phone (e.g., “User's Dinner Party”) and invite them to the party. Using a group communication system, as discussed below, the group of invited people can communicate, for example, to organize rides prior to the dinner and/or to share photos after the dinner party. If one of the guests brings a friend, the user can add the additional person to the group. After the dinner party, one of the people at the dinner party can employ the system 100 to organize a second event. The group for the second event can include none, some or all of the group for the original event as well as additional people.

The system 100 can thus facilitate dynamic group formation and subsequent sharing of content. Conventional technology has facilitated mobile communication and photo-sharing from person to person. For example, telephone calls are generally made one to one (e.g., with the option of adding individual(s) one-by-one), text and photo message can be sent to an individual or a list of individuals. However, using conventional systems there is no way for a group to communicate and share media as a group. Groups must be built up from a list of individuals one-by-one, and replies to messages go only to the sender. There is no persistence in groups over time. Thus, if one member of a family wishes to send a picture from their camera phone to everyone else in their family, they must individually select each member and send it. Comments on the photo would go only to the sender and when someone else wished to share another photo, they would have to build up the list of recipients again from scratch.

The system 100 can include a user interface component 110 that facilitates a user's entry of information and display of information regarding group formation. For example, the user interface component 110 can be employed, for example, with a mobile communication device such as a mobile phone, personal digital assistant (PDA), a smart phone, a small, web based mobile or a wireless application protocol (WAP) client, and/or a regular web client. In accordance with an aspect of the subject invention, a user can be provided with multiple interfaces via the user interface component 110 to form a group of people.

The system 100 can further include a group configuration component 120 that forms a group based, at least in part, upon information received from a user via the user interface component 110. The group configuration component 120 can further store information regarding groups, for example, a name/identifier, member(s), event(s) and/or shared context associated with the group in a group information data store 130 (e.g., database that maintains group, event, and person information). In one example, the group configuration component 120 can form a group based, at least in part, upon information stored in the group information data store 130 (implicit group formation), as discussed in greater detail below. The group information data store 130 can, optionally, provide archival access to communications and/or shared content (e.g., through a mobile communications device and/or a PC-based web browser). In one example, the group configuration component 110 and/or the group information data store 130 are physically located on a central server. In another example, the group configuration component 110 and/or the group information data store 130 are physically located on a mobile communication device.

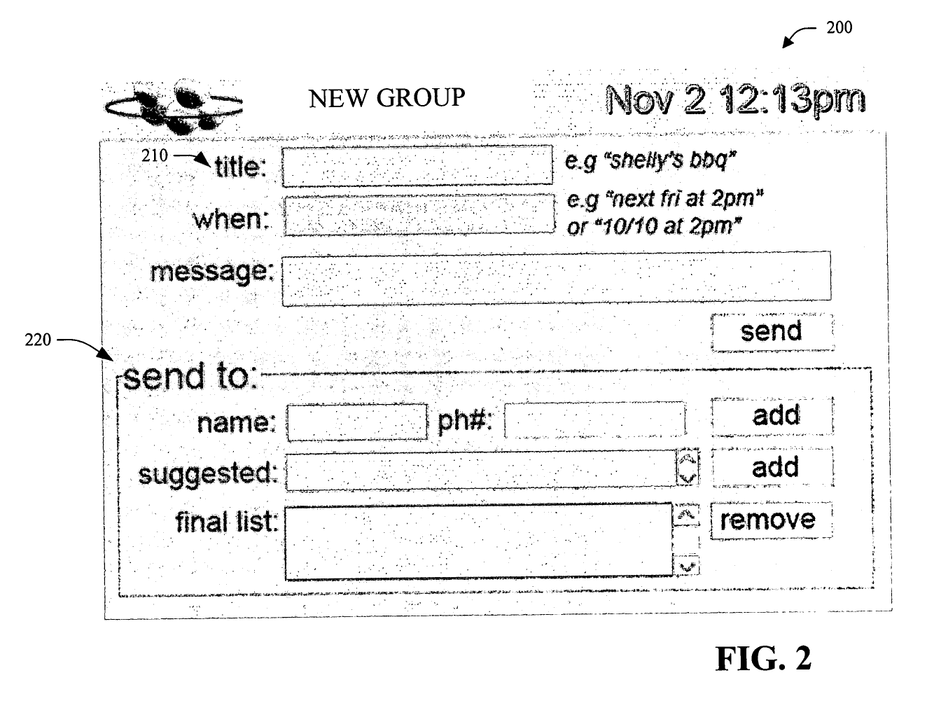

Referring briefly to FIG. 2, an exemplary user interface 200 for group formation in accordance with an aspect of the subject invention is illustrated. For example, the user interface 200 can be employed with the user interface component 110. In this example, through the user interface 200, a user can explicitly create a group for an event by giving the group a name (e.g., title 210) and selecting people to participate in the event in a group entry area 220. Additionally, the user interface 200 can display information regarding previous groups from previous events from a suggested people and groups list (e.g., stored in the group information data store 130) in the group entry area 220.

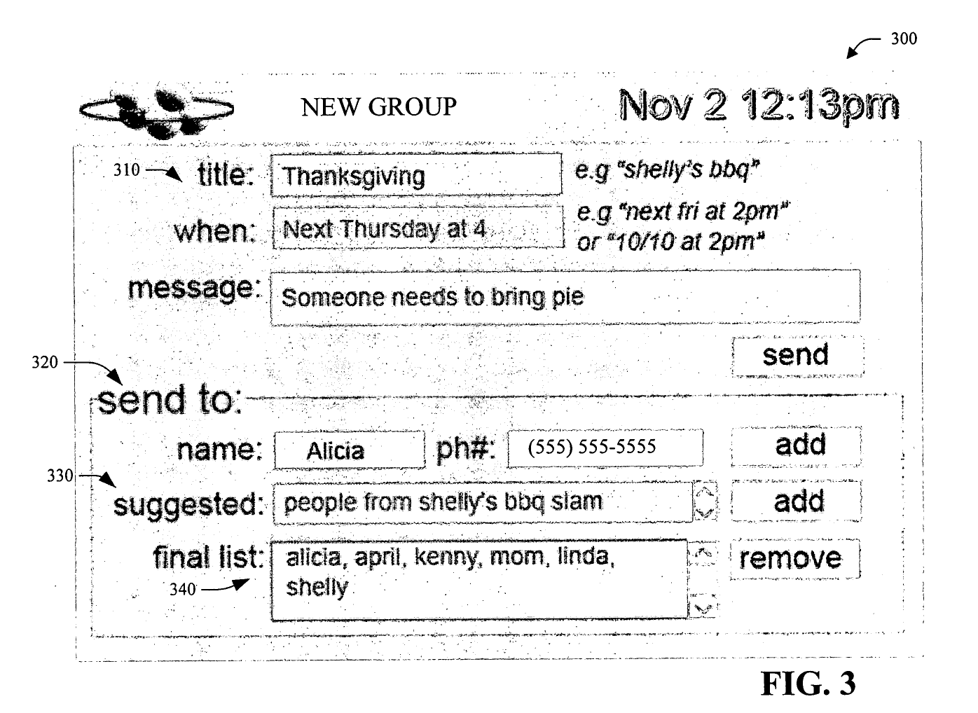

Turning to FIG. 3, an exemplary user interface 300 for group formation in accordance with an aspect of the subject invention is illustrated. In this example, the group has been given a title 310 of “Thanksgiving”. The group configuration component 120 has identified a suggested group 330 based on “people from shelly's bbq”. Using the interface 300, a user can add and/or remove people from the group, ultimately arriving at a final list 340. The suggested group(s) 330 can be based, for example, on natural grouping(s) of people during the process (e.g., frequently used communication group(s), frequently used individual(s) and/or individuals most related to already selected item(s)).

As noted previously, the group configuration component 120 can employ implicit group formation to assist a user in configuring a group. For example, by sending a message with a date attached to a group of people, an “event” for the specified date along with a group for the event can be created. In one example, if this message gets forwarded to someone not in the original group that person can become part of the group.

In another example, the group configuration component 120 can use co-occurrence in previous groups to suggest groups based on affinity between people. For example, as a user is creating a new group, the group configuration component 120 can suggest people likely to be included in the group based on a person and/or persons included initially (e.g., “seed person”). This can lead to “lightweight” group formation, that is, not requiring substantial user input. Another type of group is one with a common purpose, for example, a “Seattle camera phone photographers” group whose sole purpose was to share pictures with one another.

In yet another example, the group configuration component 120 can employ general affinity to suggest people in a group. For example, people attending a trade show that stopped at the same booths can be implicitly grouped (e.g., based on GPS and/or scanner tracking software to track which booths people visited).

Finally, the group configuration component 120 can suggest a grouping of people based on physical proximity to one another. For example, physical proximity can be determined through a location service, such as GPS and/or telecommunication-provided location, or peer-to-peer. In the peer-to-peer cases, two people can form a group, for example, when their smart devices are in close proximity. A third person can join the group when his/her device is in close proximity to one of the first two. These groups can then be used for communication and sharing. As an example scenario, people at a dinner party can become members of a group as their devices are in proximity to one another. They can then receive photos from anyone at the party (group members) taking pictures, for example.

Continuing with the exemplary user interface 300, after a group has been selected/created, to send a new event message, the user can write a text message, select a date, and click send. In this example, if the user includes a date, the message is treated as an event and is sent out as a message both immediately and on the day of the event.

Once a group has been formed by the system 100, the group can be employed for communications, content sharing and/or event planning. For example, an event can be created by sending a message to a group of people and including a date and time along with the message—the originator of the event can simply text message ‘Friday at 7’ and the system can parse this into an event at the appropriate date and time. In accordance with an aspect of the subject invention, the event planning and coordination tools can be integrated with lightweight mobile technologies such as HTTP over cellular network, SMS and/or WAP.

As noted previously, event(s) that are “open” (e.g., have not yet occurred) can be forwarded to individual(s)—recipient(s) of forwarded event(s) can automatically be added to the associated group. Additionally, user(s) can be in multiple groups (e.g., “friends” and “dinner party 3/16”).

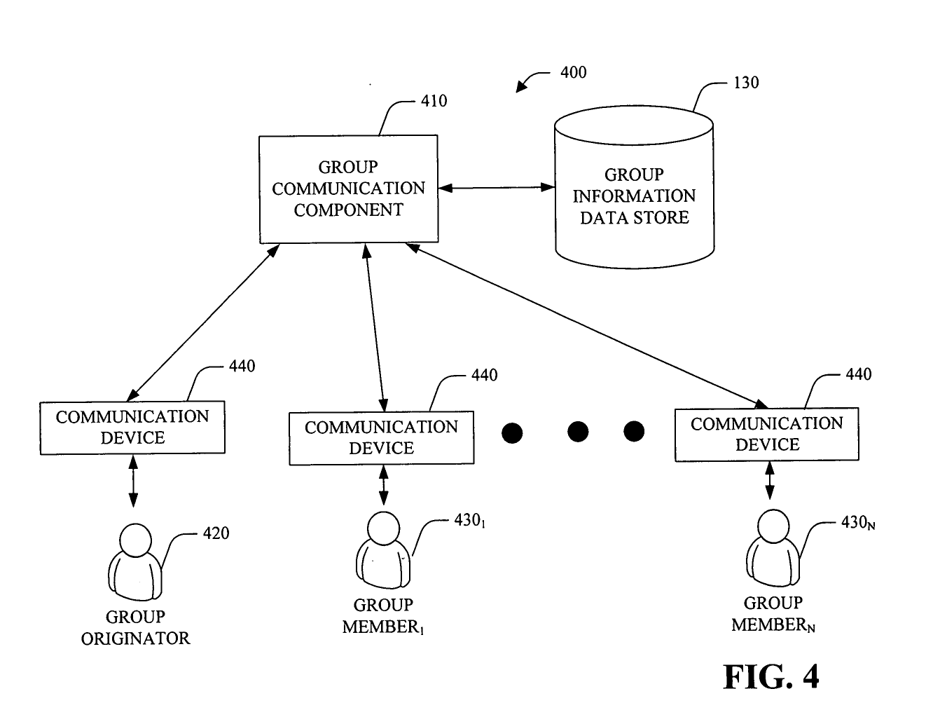

Referring next to FIG. 4, a group social interaction system 400 in accordance with an aspect of the subject invention is illustrated. The system 400 includes a group communication component 410 and a group information data store 130.

The system 400 can facilitate communication, content sharing and/or event planning/coordination among a group originator 420 and group member(s) 430. The group originator 420 and the group member 430 communicate with the group communication component 410 via communication devices 440. The communication devices 440 can include, for example, a mobile phone, a PDA, a smart phone, a small, web-based mobile or a WAP client, and/or a regular web client. The communication devices 440 can include a user interface, as discussed below, to send message(s), event(s) and/or content to group(s). Thus, the user interface can facilitate real-time sharing of text and/or media (e.g., photo(s) and/or audio) with group(s).

In one example, the group communication component 410 and/or the group information data store 130 are physically located on a central server. In another example, the group communication component 410 and/or the group information data store 130 are physically located on one or more of the communication devices 440.

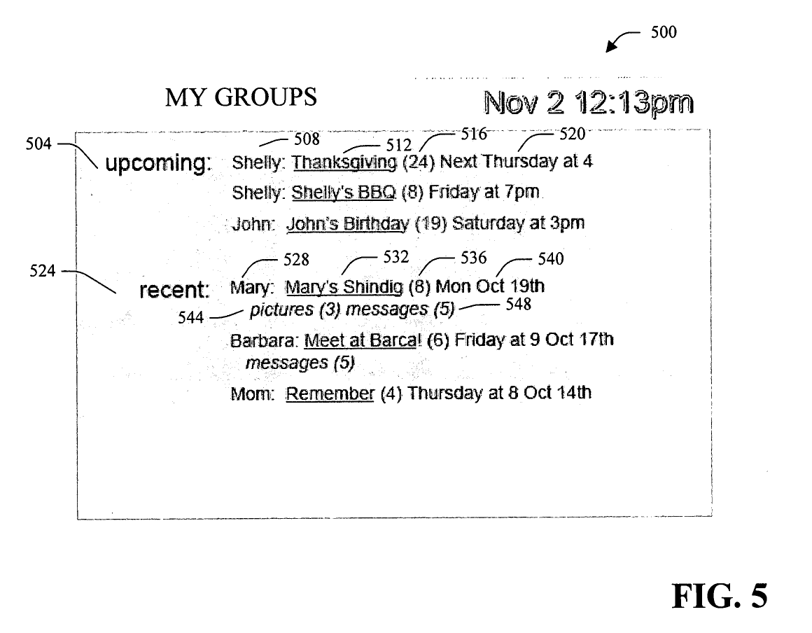

Turning next to FIG. 5, an exemplary user interface 500 in accordance with an aspect of the subject invention is illustrated. With the user interface 500, a user can review information associated with events of which the user is a member.

In this example, the user interface 500 includes an upcoming event section 540 that provides information related to event(s) that occur in the future. An entry of the upcoming event section 504 can include a group originator 508, an event name 512, a quantity of group members 516 and information regarding the event 520 (e.g., temporal). Optionally, an entry of the upcoming event section 504 can further include message(s) and/or shared content (e.g., photo of birthday gift).

The user interface 500 can further include a recent event section 524 that provides information associated with event(s) that have already occurred. An entry of the recent event section 524 can include a group originator 528, an event name 532, a quantity of group members 536 and information regarding the event 540 (e.g., temporal). Optionally, an entry of the recent event section 524 can further include information regarding shared content 544 (e.g., photo(s) taken at the event) and/or message(s) 548.

Set of Exemplary User Interfaces

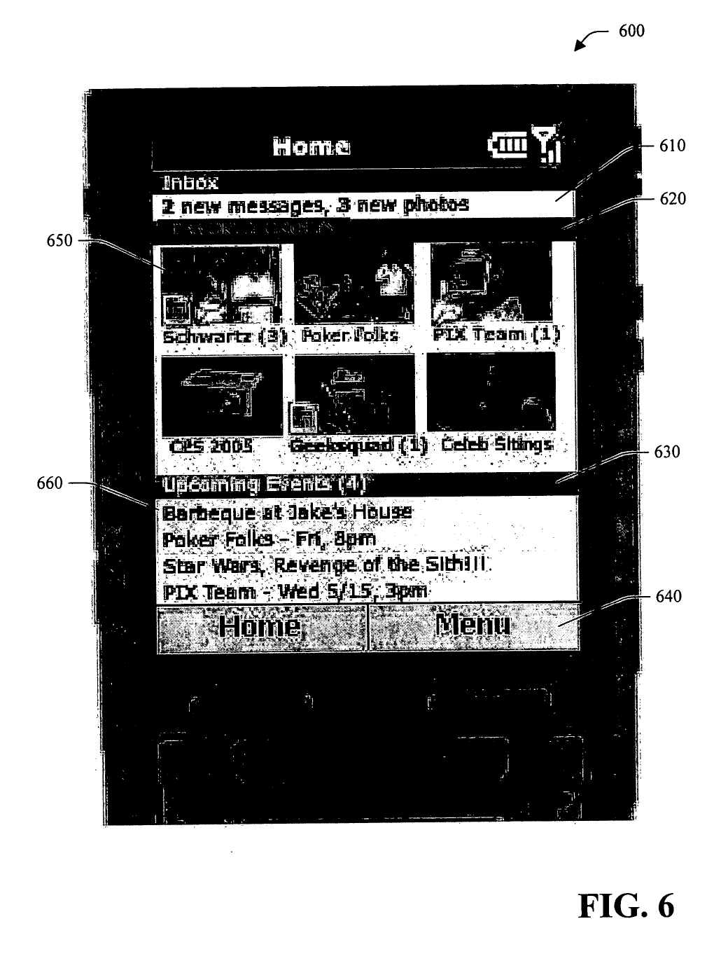

Referring to FIGS. 6-18, a set of exemplary user interfaces are provided in accordance with aspects of the subject invention. In one example, on a user's mobile phone's home screen, a single line can be added:
Group (x msg, y photos)

In this example, when a new message or photo arrives in any group, this corresponding number is updated and the phone performs the same action that is set for the arrival of a text message (e.g., vibrate). It also displays the envelope in the upper-left corner of the home screen.

Application Home

Referring next to FIG. 6, an exemplary user interface 600 in accordance with an aspect of the subject invention is illustrated. The user interface 600 can be an application home page for a user on the mobile phone, the user interface 600 comprising an inbox summary 610, favorite groups 620, event groups title 630 and a menu control 640. In this example, initial focus is set to the inbox summary 610. Clicking the inbox summary 610 opens the inbox.

Focus can be set on any of the favorite group tiles 650, the event groups heading 630 or an event group 660 itself. In one example, when on a group tile 650, the up-down key navigates between rows of the group tiles 650 and down into the event groups title 630, the right-left key navigates between columns of group tiles 650 (e.g., wrapping to the next/previous row as appropriate). Selecting a group tile 650 navigates to the appropriate group page.

Continuing with this example, when on the event groups title 630 or an event group 660, the up-down key navigates between items and the left-right key is ignored. Selecting an event group 660 navigates to the particular group page. Selecting the event group title 630 navigates to a list of event groups.

In this example, pressing “1” through “6” on a number keypad of the mobile phone navigates to the page associated with the corresponding group (e.g., upper-right tile is “1”, upper middle is “2”, etc.).

Inbox

In this example, the inbox displays the quantity of new messages and/or photo(s) the user has received, aggregated across all groups and SMS messages. Clicking the Inbox navigates the user to the Inbox page.

Group Tiles

In this example, up to six group tiles are displayed on the home page user interface 600. A graphic can be displayed for each group, for example, the most recent picture sent to the group, a generic group icon and/or a particular picture associated with the group.

An overlay can be displayed over the group tile(s) 650, as appropriate, for example, a new mail icon if there are new message(s) in the group and/or a new photo icon if there are new photo(s) in the group. The “new” flag can be cleared when the user navigates to the particular group page.

Continuing with the exemplary user interface 600, beneath a name can be displayed below a group tile 650 (e.g., if the name is longer than can be displayed, it is shown with ellipses). Additionally, if there are new photos and/or messages associated with the group, the quantity of new photo(s) and/or message(s) can be displayed in parentheses after the group name and the group name can be displayed in bold type.

Events Group

The event group header 630 is displayed at the top of the event group list. The header 630 can include a quantity of upcoming event(s) in parentheses. Clicking on the header 630 navigates to the list of events.

Beneath the header 630 is a list of the next two events, in descending date order in the format:

<event name>
<group name> - <date>, <time>

In this example, <date> and <time> can be displayed in a “friendly” fashion, for example, next seven days can be displayed as three-letter days of week, other dates as “Www m/dd”, time can be displayed as “1 pm” or “1:30 pm”. If no time is set, no time is displayed. In one example, in the event that the full text does not fit on a single line, the group name and/or event name can be truncated until the line fits.

Action Menu

In this example, the following actions are displayed when the “Menu” control 640 is pressed:

TABLE 1

| Number | Action | Result |
|---|---|---|
| 1 | Create New Group | Navigates to New Group page |
| 2 | Send Message | Navigates to Compose Message page |
| 3 | Take A Picture | Navigates to camera page |
| 4 | Options | Goes to Settings page |
| 5 | Pin Favorite Group | Navigates to Pin Favorites page |
| | | (disabled if focus is not on a group) |
| 6 | About | Displays version information |
| 7 | Quit | Exits application |

Group Page

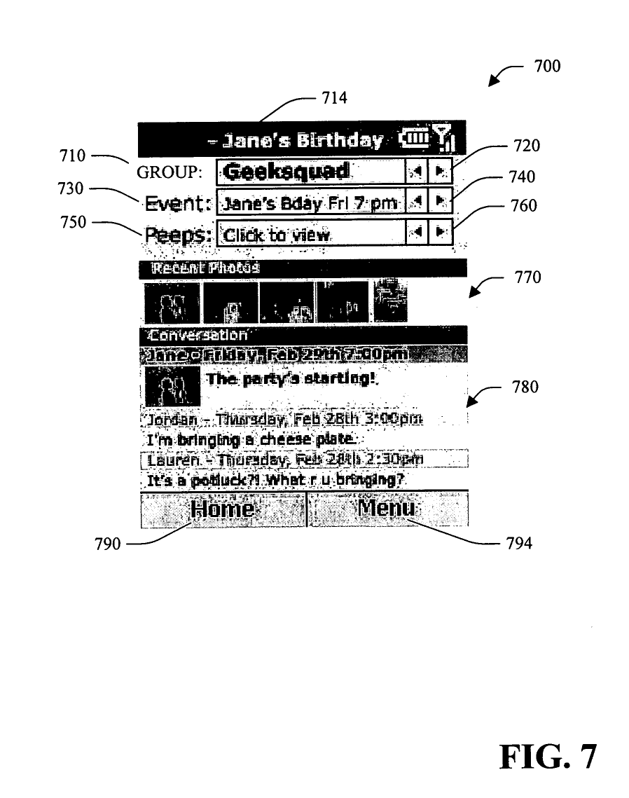

Turning next to FIG. 7, an exemplary user interface 700 in accordance with an aspect of the subject invention is illustrated. The user interface 700 can be displayed via a communication device 440 to a user (e.g. the group originator 420 and/or group member(s) 430).

In this example, the user interface 700 is associated with a particular group 710, in this example “Geeksquad”, and can include a header 714 displays a name of the group (e.g., “—Jane's Birthday”). The user can use group controls 720 to scroll through one or a plurality of groups to which the user belongs. The user interface 700 further includes an event 730 associated with the group (e.g., “Jane's Bday Fri 7 pm). The user can use user event controls 740 to scroll through zero, one or a plurality of events associated with the selected group.

The user interface 700 further includes a participant section 750 (“Peeps”). The user can use participant controls 760 to scroll through the people associated with the selected group.

Additionally, the user interface 700 includes a shared content section 770 (“Recent Photo”) in which members of the selected group can share content (e.g., photos, videos and/or audio messages). For example, thumbnail(s) of the most recent photo(s) and/or video(s) associated with the group can be displayed. Clicking on a photo can navigate to a full screen photo view.

Finally, the user interface includes a messages section 780 (“Conversation) through which the user can review message(s) associated with the selected group/event.

In this example, focus can move with an “up-down” control (not shown):
Between fields of the header;
header for recent photos;
the first most recent photo;
the name of the first message sender;
the photo/video sent by the first message sender, if present;
the name of the next message sender, etc.

Similarly, a “right-left” control (not shown) can be employed to navigate between thumbnails in the shared content section 770 (e.g., recent photos). Additionally, in situations in which there is more content than can fit on the page, the entire page can be scrolled.

The user interface 700 can further include a home control 790 which can navigate the user to the application home page, and/or a menu control 794 which, in connection with the numeric keypad can facilitate the user's interaction with the group, for example:

TABLE 2

| Number | Action | Result |
|---|---|---|
| 1 | Reply to Group | Navigates to Compose Message page, preset |
| | | to this group |
| 2 | Reply to Sender | Navigates to Compose Message page, preset |
| | | to sender of selected message (e.g., option |
| | | disabled if focus is not on a message) |
| 3 | Share Picture to | Navigates to camera page, sets defaults to |
| | this Group | this group |
| 4 | Delete Message | Deletes Message |
| 5 | Depart Group | Presents dialog asking whether the user |
| | | would really like to remove themselves from |
| | | the group. If yes, user is deleted from group |
| | | membership and the user is navigated to the |
| | | home screen. |
| 6 | Mute/Unmute | Presents dialog indicating that says “Muting |
| | Group | this group will stop new messages sent to |
| | | the group from being delivered to you, but |
| | | you will still be a member of the group. |
| | | Mute Group?” OK/Cancel. |
| | | Unmute presents dialog telling user that they |
| | | will now receive messages from the group |
| | | again. OK |
| 7 | Invite new | |
| | participant | |
| 8 | Pin Group as | Navigates to Pin Favorite page, discussed |
| | Favorite | below. |

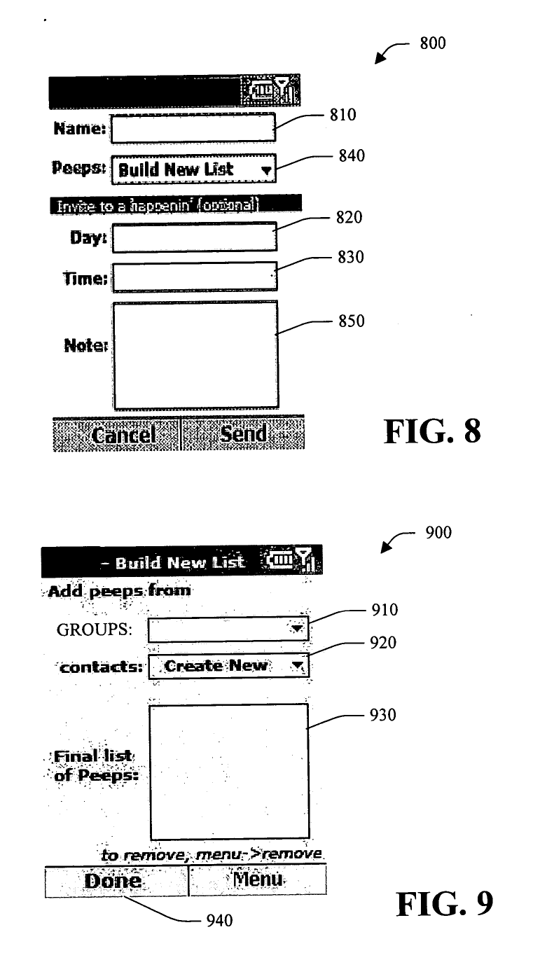

Referring next to FIG. 8, an exemplary user interface 800 in accordance with an aspect of the subject invention is illustrated. The user interface 800 can be employed to create a new group.

The user interface 800 can include a name field 810 that is used to name the group. In one example, the name field 810 is open-ended, allowing users to type in the name of their new group. In this example, the name can be up to 16 characters long. The name must be unique to the user so if it already exists in the user's system a number will be added to the end of it (e.g., birthday2) in the database, though the display name will remain the same.

Next, the user interface 800 can include a day field 820 that allows users to specify the day of the group event (e.g., optional as groups are not necessarily event specific). In this example, since it is generally expected that groups refer to a day in the next few weeks, users can specify the day only “Monday”, to refer to any of the next seven days. The system 100 can provide a date drop down, for example, so that when a user types in “m”, the system 100 can list “Monday, 3/3/2004 or Monday, 3/10/2004, or Monday, 3/17/2004, and so forth via the user interface 800.

The user interface 800 can further include a time field that allows user(s) to type in the time of an event (e.g., again, option). In one example, user(s) can type in a number, and options will appear in a drop down (e.g., provided by the system 100), for example, if the user types in “9”, then 9:00 p.m., 9:15 p.m., 9:30 p.m., 9:45 p.m., 9:00 a.m., 9:00 a.m., 9:15 a.m., 9:30 a.m., 9:45 a.m. can appear as options in the drop down list.

Further, the user interface 800 can include a participants field 840 (e.g., “peeps”). The participants field 840 allows user(s) to either select a “build new list” option, or select a past group, on the assumption that most new groups will be sent to the same list of people as past groups. For example, the list of past groups can be ordered so that the first three are the most recently used, and then the rest are ordered alphabetically. If the user selects the “build new list” option, the user can be taken to the build new list page, discussed below.

An optional note field 850 can be employed for the user to provide any additional information about the group.

If the user attempts to save the group, but has not filled in required fields, the system 100 can provide a message via the user interface 800, for example,

“Sorry, you already have a group with this message”

“Sorry, you must specify a name for this group”

“Sorry, you must specify the peeps for this group”

Briefly referring to FIG. 9, an exemplary user interface 900 in accordance with an aspect of the subject invention is illustrated. The user interface 900 can be employed by a user to build a new participant list for a particular group.

The user interface 900 can include an add participant(s) from past group(s) field 910, an add participant(s) from contacts field 920 and/or an add participant(s) final list of participant(s) field 930. The add participant(s) from past group(s) field 910 allows a user to scroll through past groups and select a past group. When the user selects a group (e.g., by clicking on it), the individual names from that group appear in the final list of participants field 930. The user can further select other group(s), if desired, with names building in the final list of participants field 930 (e.g., arranged alphabetically with duplicates, if any removed).

The add participant(s) from contacts field 920, can include, for example, a drop down of the user's contacts (e.g., with mobile phone and/or text message entries). The user can select a contact to add (e.g., by clicking on the name), at which time the contact can flash twice, then allows the user to continue choosing contacts. The added contacts can be displayed in the final list of participants field 930.

The final list of participants field 930 identifies participants selected for the group (e.g., arranged alphabetically with duplicate entry(ies) removed). When the user selects the done control 940, the system returns to the create group page discussed above.

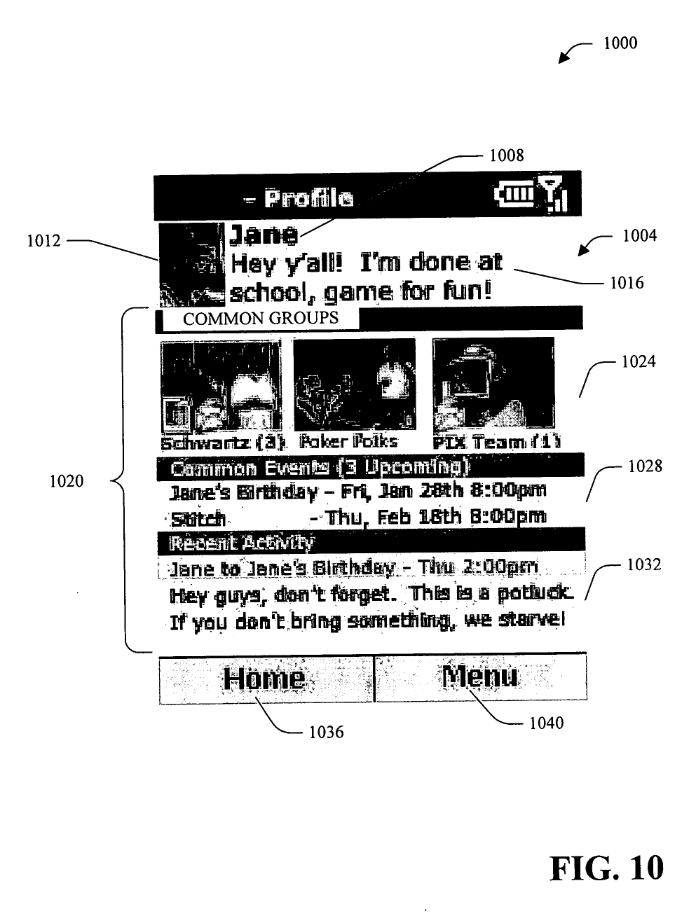

Turning next to FIG. 10, a user interface 1000 in accordance with an aspect of the subject invention is illustrated. The user interface 1000 can display profile information associated with a particular person that can include static information about the person as well as dynamically generated content, for example, from the intersection between the current user and the person whose profile is being viewed.

The user interface 1000 can include a header section 1004 having a name of the person 1008, a photo of the person 1012 and a status message set by the person 1016. The user interface 1000 can further include a content in common section 1020 that displays contains groups and recent activity in common between the current user and the person whose profile is being viewed. The content in common section 1020 can include a common groups section 1024 that displays tiles associated with common groups, a commom events section 1028 that displays information regarding common events, and/or, a recent activity section 1032 that provides a reverse chronologically ordered list of content shared with groups in common with the user (e.g., filtered view of the current user's inbox showing only content from the person currently selected). With the user interface 1000, the user has the same messaging, sharing, and publishing actions as from the group page discussed above, but with the actions applying to the person selected.

The user interface 1000 can further include a home control 1036 that navigates the user to the previous page. A menu control 1040 can further be included in the user interface 1000 which, in connection with the numeric keypad can facilitate the user's interaction with the person, for example:

TABLE 3

| Number | Action | Result |
|---|---|---|
| 1 | Send Message | Navigates to Compose Message page, preset |
| | | to this user |
| 2 | Send photo | Opens file dialogue for sharing photos |
| 3 | Send location | Opens deeper menu set containing standard |
| | | location menu items |
| 4 | Take A Picture of | Navigates to camera page, sets default to |
| | this person | this person |
| 5 | Mark as Read | Marks the selected message as read |
| | | (disabled when focus is not on an unread |
| | | message) |
| 6 | Mark as unread | Marks the selected message as unread |
| | | (disabled when focus is not on an read |
| | | message) |
| 7 | Block this person | Blocks content from person (disabled for |
| | | one's own profile) |
| 8 | Edit | Opens Edit Profile page (disabled for other |
| | | people's profiles) |
| 9 | Quit | Exits application |

In one example, when the profile being viewed is the user's own profile, the common groups section 1020 can include the user's own groups. Further, the recent activity section 1032 can include recent message(s) sent by the user. As noted in Table 3, an edit profile page can be enabled that facilitates editing of a user's profile screen (e.g., allows a user to edit the user name, about me statement, and profile photo).

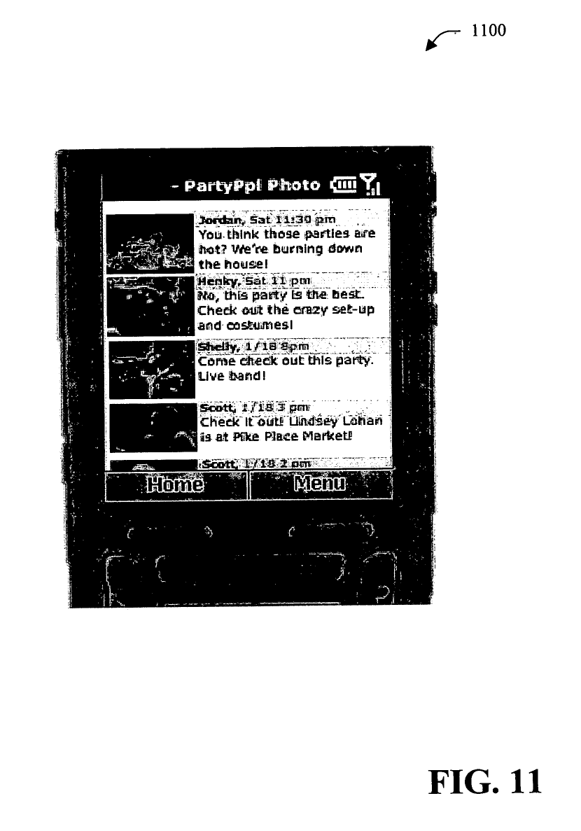

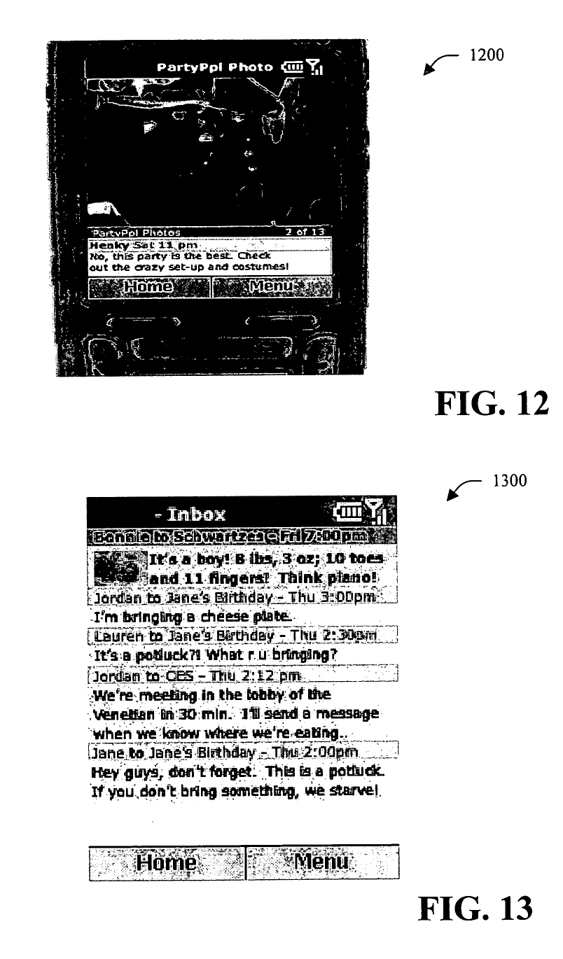

Referring next to FIG. 11, an exemplary user interface 1100 in accordance with an aspect of the subject invention is illustrated. The user interface 1100 can be employed to view photos and/or videos associated with a particular group/event. Similarly, an exemplary user interface 1200 illustrated in FIG. 12 can be employed to view a single photo and/or video associated with a particular group/event.

Turning briefly to FIG. 12, an exemplary user interface 1200 in accordance with an aspect of the subject invention is illustrated. The user interface 1200 can be employed to view a photo and/or video associated with a group/event.

Next, referring to FIG. 13, an exemplary user interface 1300 in accordance with an aspect of the subject invention is illustrated. The user interface 1300 is associated with a user's inbox and can display messages from group(s) as well as SMS messages(s). In one example, the messages are displayed in a single, descending date-ordered list. Further, message(s) can be marked “unread) until the message has been clicked on and/or focus has been set to the message.

In this example, clicking on a message displays the message full screen with a header and body. The header can include:
From whom message was sent (e.g., selectable). Clicking this field navigates to that person's Person Profile page.
Group to which the message was sent (e.g., selectable). Clicking this field navigates to the Group page. If the message was person-to-person SMS, the text “via SMS” is displayed instead of “to <group name>”.
Date and time the message was sent, for example, in format “Fri 7:12 pm”, unless message is 7 or more days old, in which case it is displayed as “Fri, 3/12 7:12 pm”.
In the event that the full header will not fit on a line, the name for the group to which the message was sent can be truncated to make it fit. If the group name is truncated to three characters and the line still doesn't fit and the message was sent today, the day can be eliminated. If the line is still too long, the From portion can additionally be truncated.

The body can display, for example, either the text of the message sent or the thumbnail of the photo sent. If the photo is accompanied by text, it is displayed to the right of the thumbnail. Selecting a thumbnail navigates to a Photo/Video Viewer (discussed above) on that photo/video.

When a message/photo is unread, it can be displayed in bold text and with a particular color background. When the user has paused focus on a message for a threshold period of time (e.g., 2 seconds) and/or when the user clicks on a message, it switches to “read” (e.g., non-bold, different color background).

In this example, navigation can be employed as follows:

Focus is initially set to first message body.

Up-down control navigates header to message to header to message.

When on a header, left-right navigates between “from” and “to”.

Clicking on a message marks it as “read”.

Clicking on from/to navigates to that person/group page.

Additionally, with a home control, a user can navigate to the application home page. Further, a menu control can be employed, for example, as follows:

TABLE 4

| Number | Action | Result |
|---|---|---|
| 1 | Reply to Group | Navigates to Compose Message page, preset |
| | | to this Group |
| 2 | Reply to Sender | Navigates to Compose Message page, preset |
| | | to sender of selected message (option |
| | | disabled if focus is not on a message) |
| 3 | Share Picture | Navigates to camera page, sets defaults |
| | to this Group | to this group |
| 4 | Mark as Read | Marks the selected message as read or |
| | (Unread) | unread, whichever it isn't. (Disabled when |
| | | focus is not on a message) |
| 5 | Delete Message | Deletes Message |
| 6 | Depart Group | Presents dialog asking whether the user |
| | | would really like to remove themselves from |
| | | the group. If yes, user is deleted from group |
| | | membership and the user is navigated to the |
| | | home screen. |
| 7 | Mute/Unmute | Presents dialog indicating that says “Muting |
| | Group | this group will stop new messages sent to |
| | | the group from being delivered to you, but |
| | | you will still be a member of the group. |
| | | Mute Group?” OK/Cancel. |
| | | Unmute presents dialog telling user that they |
| | | will now receive messages from the group |
| | | again. OK |
| 8 | Invite new | |
| | participant | |
| 9 | Pin Group as | Navigates to Pin Favorite page, as discussed |
| | Favorite | below. |

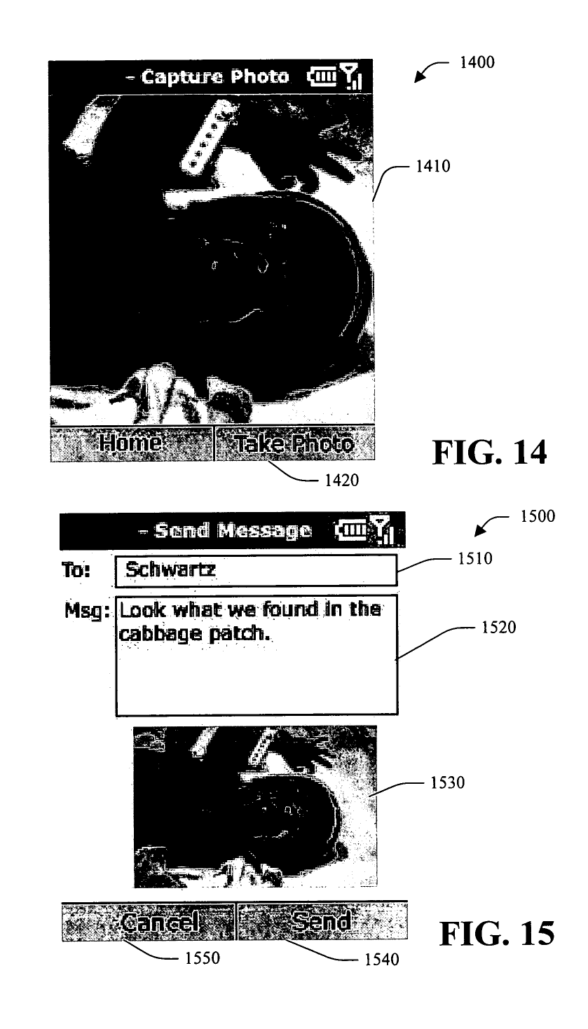

Turning to FIG. 14, an exemplary user interface 1400 in accordance with an aspect of the subject invention is illustrated. The user interface 1400 can be employed to allow a user to take a picture and send it to a particular group.

The user interface 1400 includes a display area 1410 which displays the current camera image. The user interface 1400 further includes a take photo control 1420 which captures the camera image. Thereafter, the captured image is displayed in the display area 1410 and a home control 1430 and the take photo control 1420 can be changed to “discard” and “send”, respectively. Selection of the send control (not shown) can be cause the following menu to be displayed:

TABLE 5

| Number | Action | Result |
|---|---|---|
| 1 | Send to <group name1> | Navigates to Compose Message, |
| | | focus in Msg, To: preset to group |
| | | name 1. |
| 2 | Send to <group name 2> | Navigates to Compose Message, |
| | | focus in Msg, To: preset to group |
| | | name 2. |
| 3 | Send to <group name 3> | Navigates to Compose Message, |
| | | focus in Msg, To: preset to group |
| | | name 3 |
| 4 | Send to other . . . | Navigates to Compose Message, |
| | | focus in To: |
| 5 | Save to folder | Allows user to choose a folder to |
| | | save to, preset to My Pictures |

Where <group name 1 . . . 3> are the three most likely groups. In this example, if the user came to this page from a group page, group name 1 is that group. An algorithm for determining which groups to show in the menu is as follows (populating from the rules below in order until there are no more positions):

Group that is occurring now

Group that is coming up in 24 hours

Group in first position on home page

Group that is coming up in 48 hours

Group in second and third position on home page

Referring to FIG. 15, an exemplary user interface 1500 in accordance with an aspect of the subject invention is illustrated. The user interface 1500 can be employed by a user to compose a message to send to a group. The user interface 1500 includes a “to line” section 1510, a message box 1520 and media 1530. Once an appropriate group has been entered in the to line section 1510, selecting a send control 1540 sends the message. Selecting a cancel control 1550 cancels the message.

In this example, the to line section 1510 does not accept direct input, but only adds group(s). As soon as the user begins to type, the address book is displayed and filtered down to groups for which a substring that matches what the user has typed. When a group is selected, the screen switches back to the compose page with the group's name filled in.

Additionally, a user can move left-right between names on the to line section 1510 and can erase names from the to line section 1510 by using the back-arrow. In this example, the name is erased as an entity, not as individual characters.

The media 1530 displays a thumbnail of the photo/video being sent. If no photo or video has been specified, a box with the words “Add Photo/Video . . . ” can be displayed.

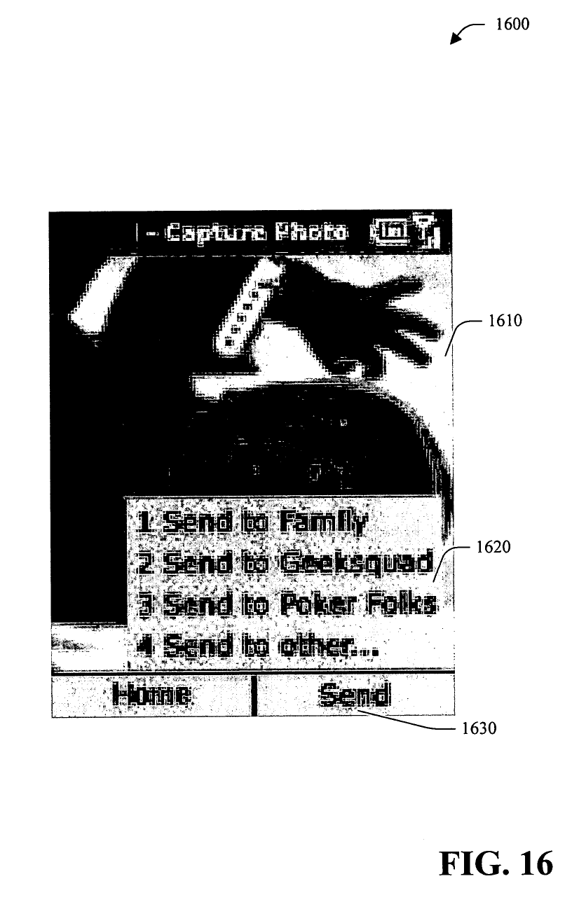

Turning briefly to FIG. 16, an exemplary user interface 1600 in accordance with an aspect of the subject invention is illustrated. The user interface 1600 can be employed, for example, to share context (e.g., a digital photo) with members of a selected group. In this example, the user interface 1600 includes a content section 1610 (e.g., digital photo of newborn) and a group(s) section 1620. The group(s) section 1620 identifies one or more groups to which a user belongs. Through the group(s) section 1620, the user can select a particular group and share the content with the group.

In this example, the photo can be sent to one of the groups identified in the group(s) section 1620 by selecting a send control 1630.

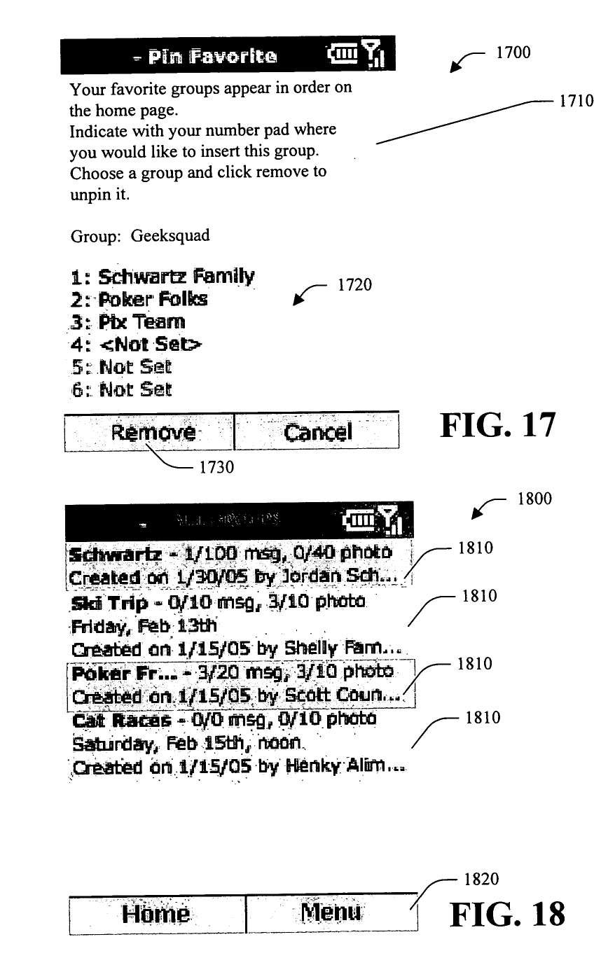

Next, referring to FIG. 17, an exemplary user interface 1700 in accordance with an aspect of the subject invention is illustrated. The user interface 1700 can be employed by a user to set which groups appear on the user's home page with unset position(s) filled by the recency algorithm discussed above.

A user can add a group 1710 into the favorites section 1720. In this example, selection of a number inserts the group into the indicated position, moving by one any group(s) already at that position or lower down. Additionally, the user can also set focus on a group and choose the remove control 1730 to unpin it as a favorite. Removing a group causes other group(s) below that group to be moved up one place.

Briefly referring to FIG. 18, an exemplary user interface 1800 in accordance with an aspect of the subject invention is illustrated. The user interface 1800 facilitates a user's review of tile(s) 1810 representing the group(s) of which the user is a member. In this example, a group is displayed as a small tile with the following information:

1^{st} line: <Name> - <# unread messages> / <# messages> msgs, <# unread
photos> / <# photos> photos
2^{nd} line: <Date>, <Time> [line omitted if not set]
3^{rd} line: Created on <create date> by <creator name>

A menu control 1820 can facilitate a user's interaction with the user interface 1800, for example:

| Number | Action | Result |
|---|---|---|
| 1 | Open | Navigates to Group page of selected group. |
| 2 | Make a favorite | Navigates to the Make a Favorite screen, |
| | | allowing user to insert selected group as |
| | | favorite. |
| 3 | Depart Group | Presents dialog asking whether the user |
| | | would really like to remove themselves from |
| | | the group. If yes, user is deleted from group |
| | | membership and the user is navigated to the |
| | | home screen. |
| 4 | Mute/Unmute | Presents dialog indicating that says “Muting |
| | Group | this group will stop new messages sent to |
| | | the group from being delivered to you, but |
| | | you will still be a member of the group. |
| | | Mute Group?” OK/Cancel. |
| | | Unmute presents dialog telling user that they |
| | | will now receive messages from the group |
| | | again. OK |
| 5 | Sort by -> | Sorts list of groups as indicated. Initially |
| | Name | ascending, but re-selecting same item |
| | Event time | toggle to descending. Check mark to left |
| | Recent Activity | indicated which is selected. |
| | Creation Date | |
| 6 | Filter to -> | Filters list as indicated. Re-selecting toggles |
| | Group | filter off. Group/Event is combinable with |
| | Event | “with unread”, but group and event are not |
| | With unread | combinable. Selecting one deselects the |
| | No filter | other. |

It is to be appreciated that the system 100, the user interface component 110, the group configuration component 120, the group information data store 130, the system 400, the group communication component 410 and/or the communication device(s) 440 can be computer components as that term is defined herein.

Additionally, those skilled in the art will recognize that the system 400 can be used to control the flow of information to other communication devices 440, for example, a ‘smart jewelry’ necklace. In this example, a user can wear a ‘smart jewelry’ necklace that is touch-sensitive. When the user touches the necklace, a similar piece of jewelry worn by the user's girlfriend can vibrate and/or flash a particular color. The two necklaces can communicate via a Bluetooth connection to each person's mobile phones, which are used for data transfer. The system 400 can be used to determine who receives what data. In this scenario, the user has specified in the system 400 that his girlfriend receives the output from his touching his smart necklace and that the output would take the form of a vibration (as opposed to a sound or light notification).

Other scenarios of this type involve multiple people. For example, when the user taps her bracelet her friend's bracelets light up. Again, the system 400 controls the recipient grouping and message typing between the ‘smart’ devices. To accomplish these scenarios, the system 400 is extensible so that groups can be bound to different communication modes and purposes.

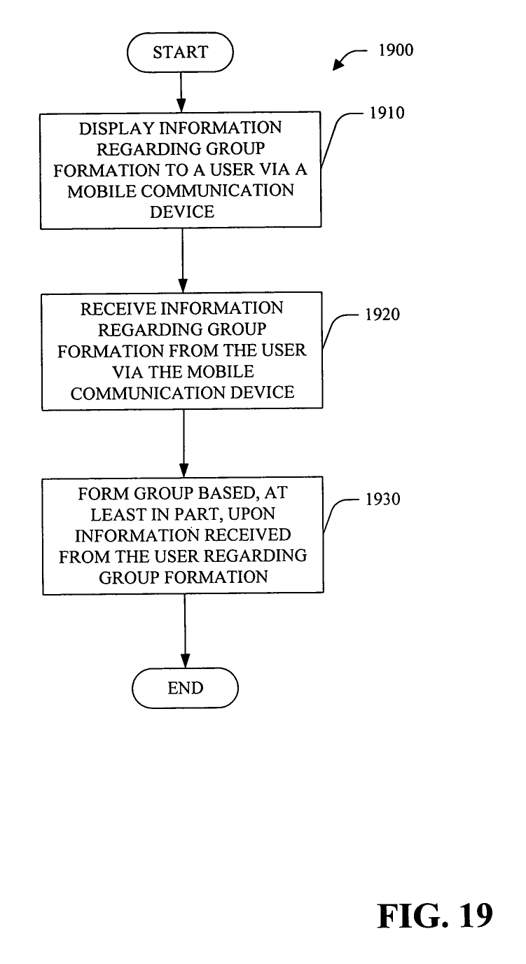

Turning briefly to FIG. 19, a methodology that may be implemented in accordance with the subject invention are illustrated. While, for purposes of simplicity of explanation, the methodology is shown and described as a series of blocks, it is to be understood and appreciated that the subject invention is not limited by the order of the blocks, as some blocks may, in accordance with the subject invention, occur in different orders and/or concurrently with other blocks from that shown and described herein. Moreover, not all illustrated blocks may be required to implement the methodology in accordance with the subject invention.

The subject invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 19, a method of forming a group 1900 in accordance with an aspect of the subject invention is illustrated. At 1910, information regarding group formation is displayed to a user via a mobile communication device. At 1920, information regarding group formation is received from the user via the mobile communication device. At 1930, a group is formed based, at least in part, upon information received from the user regarding group formation. Group formation can, optionally, be based, at least in part, upon stored information regarding previously formed groups, as discussed previously.

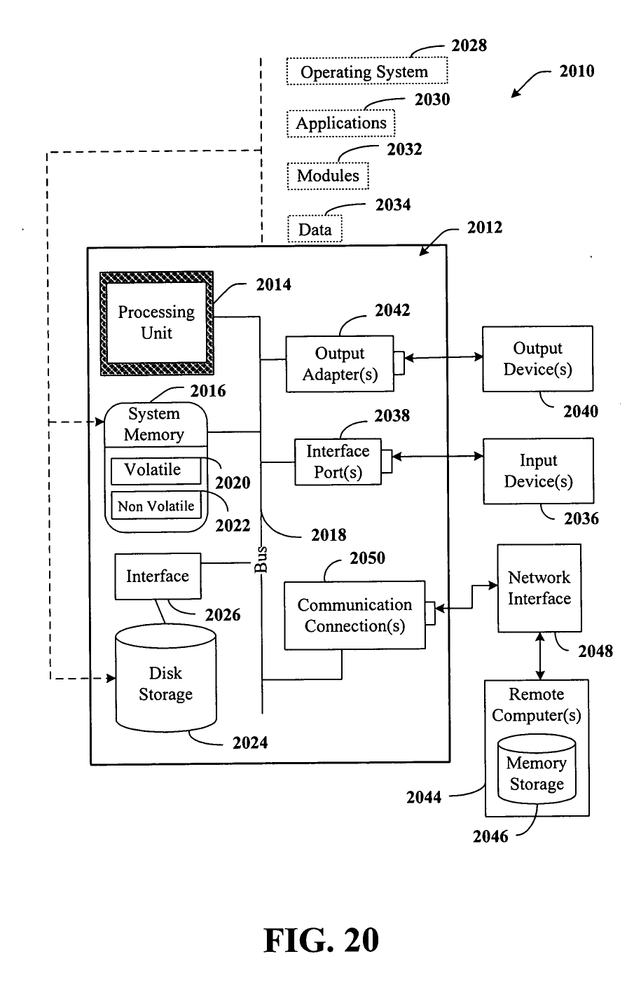

In order to provide additional context for various aspects of the subject invention, FIG. 20 and the following discussion are intended to provide a brief, general description of a suitable operating environment 2010 in which various aspects of the subject invention may be implemented. While the subject invention is described in the general context of computer-executable instructions, such as program modules, executed by one or more computers or other devices, those skilled in the art will recognize that the subject invention can also be implemented in combination with other program modules and/or as a combination of hardware and software. Generally, however, program modules include routines, programs, objects, components, data structures, etc. that perform particular tasks or implement particular data types. The operating environment 2010 is only one example of a suitable operating environment and is not intended to suggest any limitation as to the scope of use or functionality of the subject invention. Other well known computer systems, environments, and/or configurations that may be suitable for use with the subject invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 20, an exemplary environment 2010 for implementing various aspects of the subject invention includes a computer 2012. The computer 2012 includes a processing unit 2014, a system memory 2016, and a system bus 2018. The system bus 2018 couples system components including, but not limited to, the system memory 2016 to the processing unit 2014. The processing unit 2014 can be any of various available processors. Dual microprocessors and other multiprocessor architectures also can be employed as the processing unit 2014.

The system bus 2018 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 2016 includes volatile memory 2020 and nonvolatile memory 2022. The basic input/output system (BIOS), containing the basic routines to transfer information between elements within the computer 2012, such as during start-up, is stored in nonvolatile memory 2022. By way of illustration, and not limitation, nonvolatile memory 2022 can include read only memory (ROM), programmable ROM (PROM), electrically programmable ROM (EPROM), electrically erasable ROM (EEPROM), or flash memory. Volatile memory 2020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 2012 also includes removable/nonremovable, volatile/nonvolatile computer storage media. FIG. 20 illustrates, for example a disk storage 2024. Disk storage 2024 includes, but is not limited to, devices like a magnetic disk drive, floppy disk drive, tape drive, Jaz drive, Zip drive, LS-100 drive, flash memory card, or memory stick. In addition, disk storage 2024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 2024 to the system bus 2018, a removable or non-removable interface is typically used such as interface 2026.

It is to be appreciated that FIG. 20 describes software that acts as an intermediary between users and the basic computer resources described in suitable operating environment 2010. Such software includes an operating system 2028. Operating system 2028, which can be stored on disk storage 2024, acts to control and allocate resources of the computer system 2012. System applications 2030 take advantage of the management of resources by operating system 2028 through program modules 2032 and program data 2034 stored either in system memory 2016 or on disk storage 2024. It is to be appreciated that the subject invention can be implemented with various operating systems or combinations of operating systems.

A user enters commands or information into the computer 2012 through input device(s) 2036. Input devices 2036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2014 through the system bus 2018 via interface port(s) 2038. Interface port(s) 2038 include, for example, a serial port, a parallel port, a game port, and a universal serial bus (USB). Output device(s) 2040 use some of the same type of ports as input device(s) 2036. Thus, for example, a USB port may be used to provide input to computer 2012, and to output information from computer 2012 to an output device 2040. Output adapter 2042 is provided to illustrate that there are some output devices 2040 like monitors, speakers, and printers among other output devices 2040 that require special adapters. The output adapters 2042 include, by way of illustration and not limitation, video and sound cards that provide a means of connection between the output device 2040 and the system bus 2018. It should be noted that other devices and/or systems of devices provide both input and output capabilities such as remote computer(s) 2044.

Computer 2012 can operate in a networked environment using logical connections to one or more remote computers, such as remote computer(s) 2044. The remote computer(s) 2044 can be a personal computer, a server, a router, a network PC, a workstation, a microprocessor based appliance, a peer device or other common network node and the like, and typically includes many or all of the elements described relative to computer 2012. For purposes of brevity, only a memory storage device 2046 is illustrated with remote computer(s) 2044. Remote computer(s) 2044 is logically connected to computer 2012 through a network interface 2048 and then physically connected via communication connection 2050. Network interface 2048 encompasses communication networks such as local-area networks (LAN) and wide-area networks (WAN). LAN technologies include Fiber Distributed Data Interface (FDDI), Copper Distributed Data Interface (CDDI), Ethemet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2050 refers to the hardware/software employed to connect the network interface 2048 to the bus 2018. While communication connection 2050 is shown for illustrative clarity inside computer 2012, it can also be external to computer 2012. The hardware/software necessary for connection to the network interface 2048 includes, for exemplary purposes only, internal and external technologies such as, modems including regular telephone grade modems, cable modems and DSL modems, ISDN adapters, and Ethernet cards.

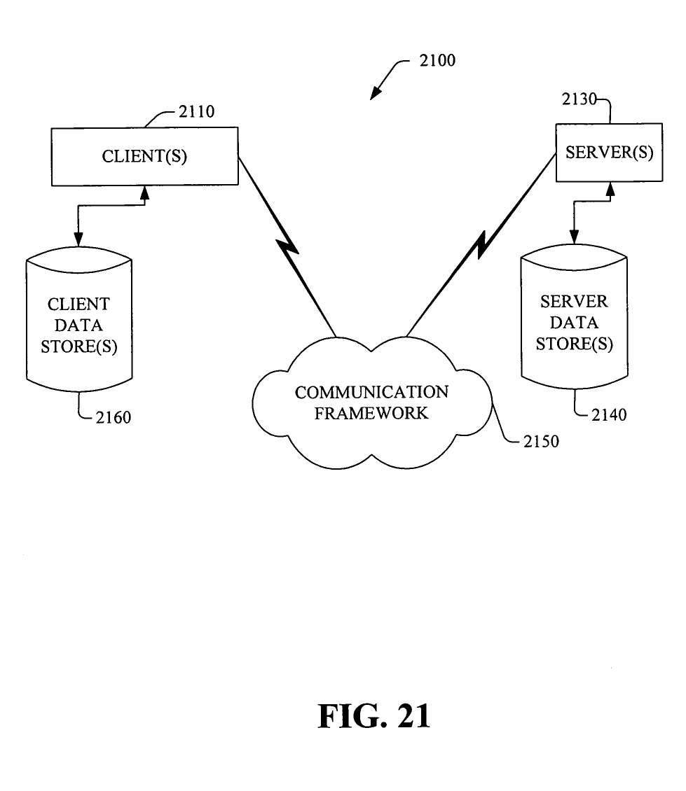

FIG. 21 is a schematic block diagram of a sample-computing environment 2100 with which the present invention can interact. The system 2100 includes one or more client(s) 2110. The client(s) 2110 can be hardware and/or software (e.g., threads, processes, computing devices). The system 2100 also includes one or more server(s) 2130. The server(s) 2130 can also be hardware and/or software (e.g., threads, processes, computing devices). The servers 2130 can house threads to perform transformations by employing the present invention, for example. One possible communication between a client 2110 and a server 2130 can be in the form of a data packet adapted to be transmitted between two or more computer processes. The system 2100 includes a communication framework 2150 that can be employed to facilitate communications between the client(s) 2110 and the server(s) 2130. The client(s) 2110 are operably connected to one or more client data store(s) 2160 that can be employed to store information local to the client(s) 2110. Similarly, the server(s) 2130 are operably connected to one or more server data store(s) 2140 that can be employed to store information local to the servers 2130.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A group formation system comprising:
a mobile communication device having a user interface component that displays information regarding group formation to a user and receives information from the user regarding group formation; and,
a group configuration component that forms a group based, at least in part, upon information received from the user via the user interface component.

2. The system of claim 1, formation of the group by the group configuration component further based, at least in part, upon stored information regarding previously formed groups.

3. The system of claim 2, the stored information comprising at least one of a name/identifier, members, events and shared content of the previously formed groups.

4. The system of claim 2, the information regarding previously formed groups stored in a group information data store.

5. The system of claim 4, the group information data store comprising a database.

6. The system of claim 1, formation of the group by the group configuration component further based, at least in part, upon a physical location of potential members of the group.

7. The system of claim 1, the mobile communication device comprising one of a mobile phone, a personal digital assistant, a smart phone, a web-based mobile client and a wireless application protocol client.

8. The system of claim 1, the formed group is a persistent group.

9. The system of claim 1, the formed group is an event-based group.

10. The system of claim 1, the user interface displays information regarding previously formed groups to assist the user in providing information regarding the group to be formed by the group formation component.

11. A group social interaction system that employs the group formed by the system of claim 1.

12. The group social interaction system of claim 11, further comprising a group communication component that employs the formed group to provide information to a plurality of communication devices.

13. The group social interaction system of claim 12, the communication devices comprising at least one of a mobile phone, a personal digital assistant, a smart phone, a web-based mobile client and a wireless application protocol client and a web client.

14. The group social interaction system of claim 12 employed to send a message to the formed group.

15. The group social interaction system of claim 12 employed to share content with the formed group.

16. The group social interaction system of claim 15, the shared content comprising at least one of a digital photograph, a digital video and a digital audio message.

17. A method of forming a group comprising:
displaying information regarding group formation to a user via a mobile communication device;
receiving information regarding group formation from the user via the mobile communication device; and,
forming a group based, at least in part, upon information received from the user regarding group formation.

18. The method of claim 17, forming of the group further based, at least in part, upon stored information regarding previously formed groups.

19. A computer readable medium having stored thereon computer executable instructions for carrying out the method of claim 17.

20. A data packet transmitted between two or more computer components that facilitates group social interaction, the data packet comprising:
a data field comprising information associated with a group, the group formed based, at least in part, upon information received from a user via a mobile communication device having a user interface component that displays information regarding formation to a user and receives information from the user regarding group formation.
